(19) United States
(12) Patent Application Publication
(10) Pub. No.: US 2004/0216776 A1
(43) Pub. Date: Nov. 4, 2004

(54) Rolling cane, walker-trainer, shopper with automatic braking

(76) Inventor: John Francis Otis, Center Hill, FL (US)

Correspondence Address: John F. Otis, P.O. Box 185, Center Hill, FL, 33514, US

(21) Appl. No.: 10/794,209

(22) Filed: Mar. 5, 2004

Related U.S. Application Data
(60) Provisional application No. 60/453,184, filed on Mar. 10, 2003.

(51) Int. Cl. A45B 1/00; A45B 7/00; A45B 9/00; A45B 1/02; A61H 3/02

(52) U.S. Cl. 135/85

(57) ABSTRACT

A lightweight metal or plastic framework which has a handle (11) at the top of an adjustable vertical shaft (12) with built in hooks (13,14) below the handle and a bottom shaft (15) attached to the end of the vertical shaft (12).

The said bottom shaft (15) is bent down at both ends on which are attached friction tips (16, 17) that act as bumpers and a braking mechanism when said framework is leaned toward the user. Two bearing fitted wheels (18, 19) are attached to said bottom shaft (15) by axles (20, 21).

### CROSS-REFERENCE

This application claims the benefit of PPA Serial No. 60/453,184, filed 2003, Mar. 10 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to walking aids, specifically those that are strong, lightweight, easily maneuverable and stable. Referred to as WTS in this application. Optional adaptations allow the adjusting of the handle for easy transportation.

2. Discussion of Prior Art

As the cane forms a basic structure this is the point to which the inventor has turned. The following US. patents are presentations to fill a need.

U.S. Pat. No. 6,158,453 to Nasco the four wheel cane with brake is equipped with soft rubber wheels. This would appear difficult to maneuver in tight spots and require lifting the front wheels in order to brake.

U.S. Pat. No. 5,692,533 to Meltzer a cane with two front wheels and two rear legs with friction stoppers. This cane has to be held up in order to move. It must be lifted and turned in order to change direction.

U.S. Pat. No. 5,588,457 to Tartaglia an attempt to give stability and maneuverability to user.

U.S. Pat. No. 4,962,781 to Kanbar a well thought out presentation which appears to obtain the objects for which it was developed. Although not designed for assisting in carrying objects, it would be portable but how strong and stable is the question.

U.S. Pat. No. 2,683,461 to Kinney used by the blind with the braking action effective when the ground engaging wheel drops over a curb or in a depression.

U.S. Pat. No. 1,494,508 to Smith a roller cane with a shank that pivots on uneven ground.

It was designed to aid a blind person to walk in a straight line on sidewalks that had seams.

Several of the inventions one by Kanbar the other by Tartaglia both express objects and goals this inventor has addressed by the present WTS, that is, providing a lightweight, strong, stable platform, whereon the user may lean or even sit on the handle. The WTS is designed to carry bags or parcels as well as attached items which were not a consideration in the above mentioned art.

3. Objects and Advantages

Accordingly, several objects and advantages of my WTS are found in the strong lightweight metal or plastic framework that is not bulky but easy to move on bearing fitted wheels. The length of the bottom shaft gives a sense of stability when using the WTS. The user can stop the WTS movement by leaning the WTS towards themselves. The WTS is also designed to carry bags and packages. To rest the user can lean/sit on the handle. The design shown in PPA application 60/453,184 operates better on rough surfaces then the preferred model with braking capabilities which is designed for smooth surfaces. Further objects and advantages of my invention will become apparent from a consideration of the drawings and ensuring description. Since each WTS is made to fit the individual user, there is an information sheet of personal specifications which each user, doctor, therapist or trainer must fill out and submit in order to complete a custom fit. The construction of the WTS will help determine the stability of the user which is the relationship between an aid and the user.

Following is a sample personal specification sheet:

1) List all limbs that are available to use.

2) Do you have any prosthetics?

3) Which hand will you use to control the walking aid?

4) Are you right or left handed?

5) Which side of the body would the walker be used on?

6) What is your weight?

7) What is your height?

8) With your arms dropped to your side what is the measurement from the floor to your wrists when you are standing? (You may need help getting these measurements.)

The above questions are a partial list of some of the information that may be required to construct the WTS.

### SUMMARY

In accordance with the present invention a WTS comprises a strong framework with or without braking capabilities, custom fitted to offer the user an optimum amount of security and safety. Although not required the user is recommended to have a professional fitting.

### DRAWINGS—FIGURES

FIG. 1 shows a left side view of WTS

FIG. 2 shows a right side view of WTS

FIG. 3 shows a front view of WTS

FIG. 4 shows a rear view of WTS

FIG. 5A shows a top view of WTS

FIG. 5B shows a bottom view of WTS

FIG. 6A shows a side view of the optional fold down mechanism

FIG. 6B shows a end view of the optional fold down mechanism

### DRAWINGS—REFERENCE NUMERALS

10 Handle Cover

11 Handle

12 Vertical Shaft

13 Front Hook

14 Rear Hook

15 Bottom Shaft

16 Front Friction Tip/Bumper

17 Rear Friction Tip/Bumper

18 Front Wheel and Bearing

19 Rear Wheel and Bearing

20 Front Wheel Axle

21 Rear Wheel Axle

22 Washer

23 Washer/Spacers

24 Side View Folding Handle Plate(s)

25 End Cutaway View of Mechanism

26 Snap Button

27 Ball Axle

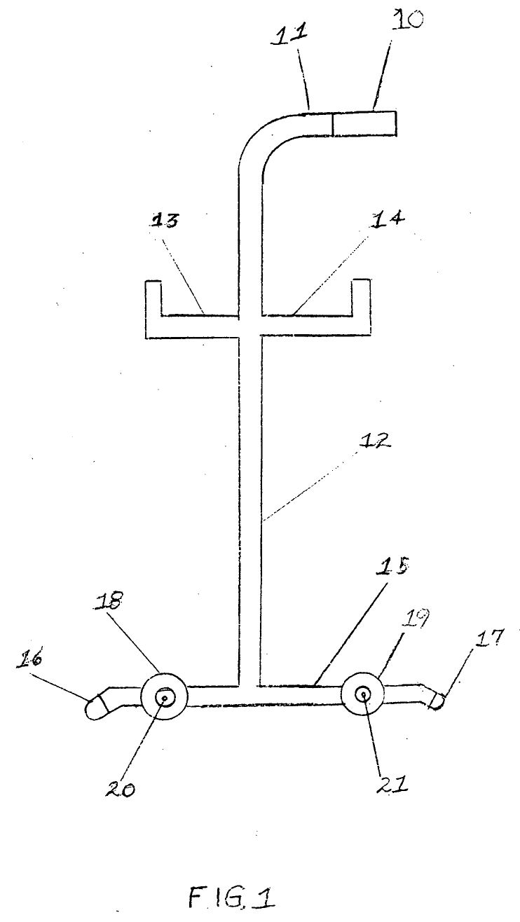

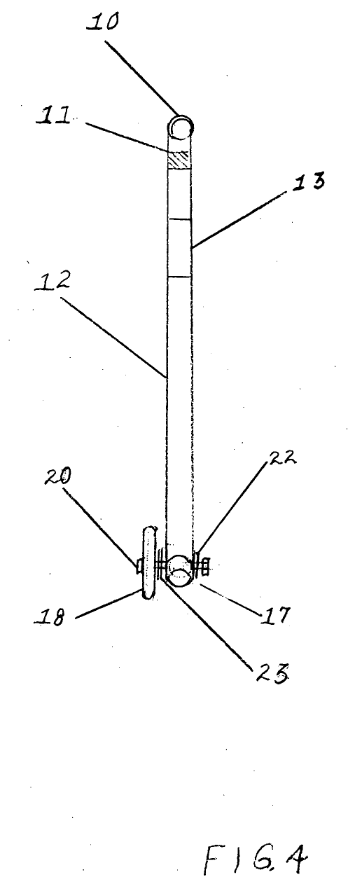

### DETAILED DESCRIPTION—FIGS. 1-4 PREFERRED EMBODIMENT

The preferred embodiment of the WTS is found illustrated in the drawings FIGS. 1-4.

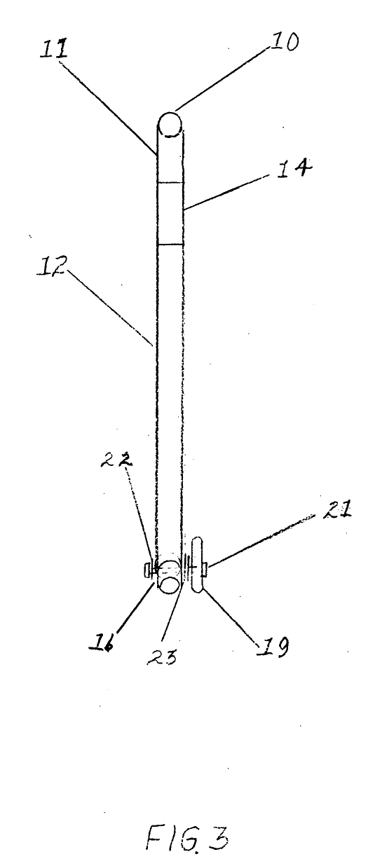

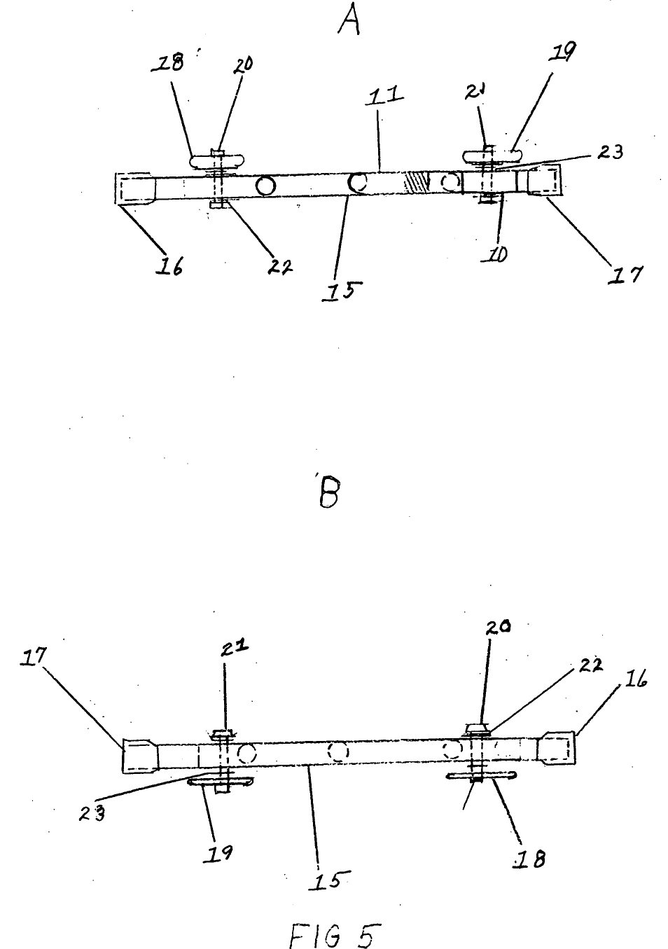

FIG. 1 starting with the handle cover 10 which slides on the handle 11. The handle is bent from the upper end of the vertical shaft 12 which is connected to the bottom shaft 15. The ends of the bottom shaft 15 are bent at an angle and attached to two friction bumpers which act as protection for the shaft ends and brakes for the WTS. Wheels 18 and 19 attach to the bottom shaft 15 by axles 20 and 21 which are shown in more detail in FIGS. 3 through 5. Two innovations are to aid the user in carrying loose objects. These are hooks 13 and 14.

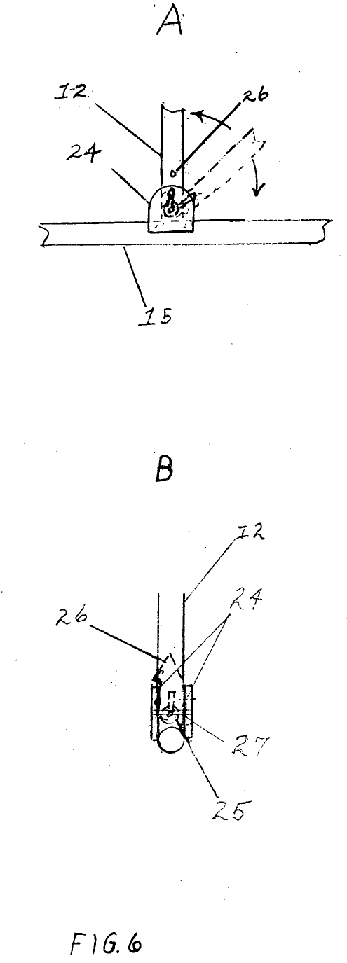

FIG. 6—Additional Embodiments

Additional embodiments are shown on FIG. 6, A and B. The left side view of 6A shows one side plate 24 with a cutaway view showing the working mechanism of a ball and stem that rotates on an axle shown in view 6B. The axle is connected between the plates 24 which are attached to the bottom shaft 15. In FIG. 6 views A and B a button 26 is shown coming through shaft 12 and locking device for shaft 12. An elastic rope or collar can hold shaft 12 and shaft 15 when button 26 is released. Hooks 13 and 14 can be adjusted for this model of WTS. The snap button units are obtained from VALCO in North Royalton, Ohio. A kickstand adaptation similar to a bicycle stand may be attached to the bottom shaft 15 or vertical shaft 12 allowing it to stand by itself. The ball and stem seen in FIG. 6 views A and B can be found in a plumbing shop.

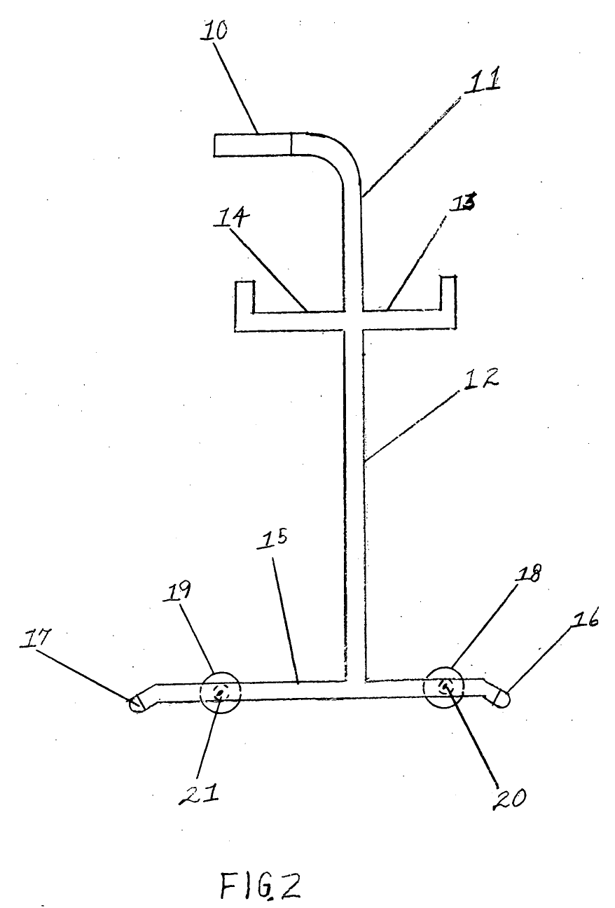

Operation—FIGS. 1, 2

The manner of using the WTS is simpler than leading a baby. With its light weight it is easily guided by a twist of the wrist aiming the WTS in the direction desired. By leaning the WTS toward the user the friction tips number 16 and 17 engage the surface, stopping motion. When the WTS is so inclined and locked by the friction tips so it doesn't move, it becomes a resting support where one is able to sit or lean on/or against the handle. The design, strength of material and light weight allow for freedom in movement.

### CONCLUSION—RAMIFICATIONS AND SCOPE

Accordingly, the reader will see that the WTS had adaptations that when applied allow it to be used for different applications. By changing the structure slightly it would adjust to other uses. Although the description before contains many specificity's, these should not be construed as limiting the scope of the invention but merely providing illustrations of some of the presently preferred embodiments of this invention.

I claim:

1. A stable solid rolling cane, comprising:
a. a lightweight framework having rotatable wheels attached to a bottom part of said framework enabling said framework to roll along a surface,
b. at top of said framework is an adjustable handle to which physical energy is applied by which motion and direction of said framework is determined,
c. means for controlling and stopping said framework is decided by applied motion of leaning said framework toward user thus engaging end friction tips of said framework to said surface.
